(19) United States
(12) Patent Application Publication
(10) Pub. No.: US 2004/0113436 A1
(43) Pub. Date: Jun. 17, 2004

(54) Coded lock II

(76) Inventors: Ulrich Bantle, Empfingen (DE); Rudolf Samann, Balingen (DE); Rudolf Faude, Balingen (DE)

Correspondence Address: Pauley Petersen Kinne & Erickson, Suite 365, 2800 W. Higgins Road, Hoffman Estates, IL, 60195, US

(21) Appl. No.: 10/602,525

(22) Filed: Jun. 24, 2003

(30) Foreign Application Priority Data
Aug. 14, 2002 (DE) 102 37 985.8

(51) Int. Cl. E05C 3/06

(52) U.S. Cl. 292/201

(57) ABSTRACT

A lock with a bolt, which can be displaced by an actuating element between an opened position and a locked position, wherein a blocking piece, which blocks the actuating element in the locked position, is assigned to the actuating element, and wherein the blocking piece can be moved from the locked position into the opened position by a solenoid. In order to assure a dependable operation of such a lock, the blocking piece can be moved out of the opened position into the locked position by a manually operable actuating part. A switching element emits a switching signal when the blocking piece reaches the locking position, or makes a transition from the opened position into the locked position.

### BACKGROUND OF THE INVENTION

1. Field of the Invention

This invention relates to a lock with a bolt, which can be displaced by an actuating element between an opened position and a locking position, wherein a blocking piece, which blocks the actuating element in the locking position, is assigned to the actuating element, and wherein the blocking piece can be moved from the locking position into the opened position by a solenoid.

2. Discussion of Related Art

A lock is known from German Patent Reference DE 299 23 398 U1. The actual locking mechanism is contained in a lock housing and has an actuating member, which is rotatably seated in the form of an actuating nut in the lock housing. As the bolt, the actuating member drives a locking bolt and/or slide or rotary rod mechanism, which can be moved out of the housing. In the locking position, the actuating member can be blocked by a solenoid which positively engages the actuating member by a blocking piece. The ability of the actuating member to rotate is thus prevented. The solenoid must be electrically activated for releasing the actuating member again.

### SUMMARY OF THE INVENTION

It is one object of this invention to provide a lock of the type mentioned above but which operates dependably and has a simple structure.

This object is attained with a blocking piece that can be moved out of the opened into the locking position by a manually operable actuating part. A switching element emits a switching signal when the blocking piece has reached the locking position, or makes a transition from the opened position into the locking position.

With this design of the lock, the actuating element takes on at least a part of the displacement of the blocking piece, so that no electric energy is necessary for this purpose. This has an advantageous effect, in particular in connection with battery-supplied locks. A switching signal is issued by the switching element during the transition of the blocking piece into the locking position. This can be evaluated as an activating confirmation to prove that the blocking piece is correctly moved into the locking position. For example, the switching signal can be processed by the signals of a code input device. If a code is entered and the blocking piece is moved into the locking position, the end of the locking process can be confirmed by the switching signal. In this case the code input device can only be unblocked after the correct code is again entered.

In accordance with a preferred embodiment of this invention, the actuating element has a lever which moves the blocking piece from the opened position into the locking position by a key element. The keying pressure applied to the key element can be geared down and/or its effective direction can be redirected.

Thus the blocking piece is a part of an actuator which, in the opened position, is maintained under spring prestress against a permanent magnet, and which can be lifted off the permanent magnet by a lever. The actuating element only needs to act in the beginning for displacing the blocking piece. Once the spring force is greater than the holding force of the permanent magnet, the spring moves the actuating member.

In accordance with one embodiment, the blocking piece is a part of an actuator which, in the locking position, is maintained against a permanent magnet, and the actuator can be moved from the opened position to the locking position by a lever against the force of a spring. In that case, the blocking piece can be moved out of the locking position in an electrical current efficient manner, with an electromagnet. The tightening of the spring is performed manually.

In order to maintain an unequivocal operating position of the actuating element, the actuating element is maintained under spring tension in an initial position associated with the open position of the lock.

Operating the switching element can take place either with the switching element operated indirectly or directly by the actuating element for transmitting the switching signal, or with the switching element indirectly or directly operated by the blocking piece or by the actuator which is connected with the blocking piece.

The lock structure is considerably simplified if the actuator is the armature of the solenoid.

There is dependable and stable securing of the blocking piece in the locking position if the actuating element is rotatably seated around an axis of rotation in a lock housing, and if the actuating element has a receptacle for the blocking piece which forms a stop in the circumferential direction on one or both sides of the inserted blocking piece.

The dependable operation of the lock is further improved if in the locking position the actuating element blocks the displacement in the direction toward the actuating element in the locking position.

### BRIEF DESCRIPTION OF THE DRAWINGS

This invention is explained in view of exemplary embodiments shown in the drawings, wherein:

FIG. 1 is a lateral partial sectional view of a lock in an opened position;

FIG. 2 shows the lateral partial sectional view in accordance with FIG. 1, but with the lock in a locking position;

FIG. 3 shows the lateral partial sectional view in accordance with FIG. 2, but with the lock blocked; and

FIG. 4 shows the lateral partial sectional view in accordance with FIGS. 1 to 3 in the blocked locking position, but with a slightly modified structure.

### DESCRIPTION OF PREFERRED EMBODIMENTS

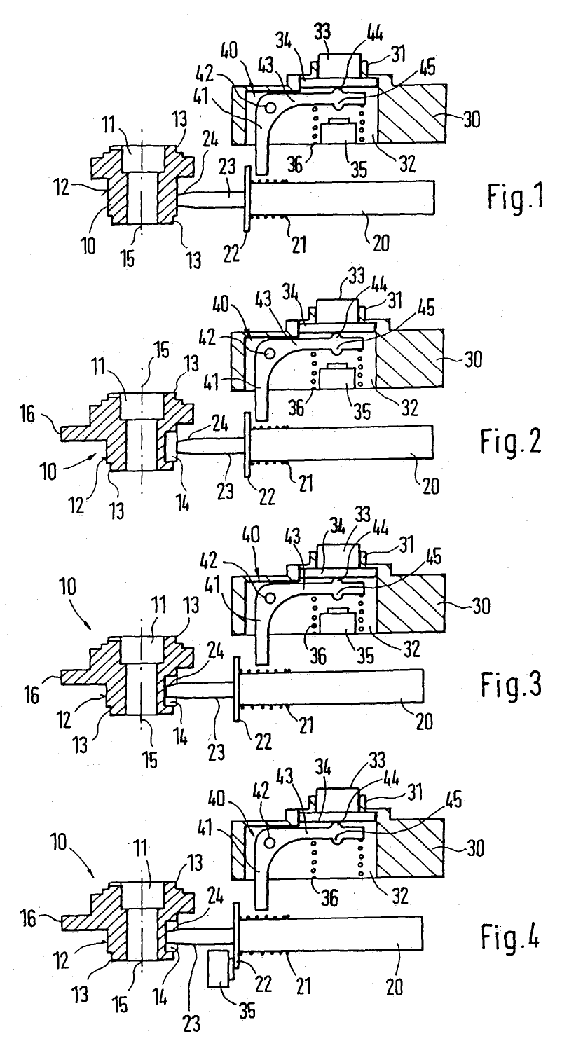

A lock is partially shown in FIG. 1. The lock has an actuating element 10, which is seated, rotatable around an axis of rotation 15, in a lock housing. For this purpose, the actuating element 10 has two seating sections 13. The actuating element 10 has a handle receptacle 11 in which a handle or a locking mechanism can be fastened, fixed against relative rotation. A radially protruding eccentric device 16 is provided in the area of a lateral face 12 of the actuating element 10, as shown in FIG. 2. It is used to move a bolt seated in the lock housing back and forth between an opened position and a locking position.

As shown in FIG. 3, a receiver 14 in the shape of a depression is cut into the lateral face 12 and is aligned with a blocking piece 24, which is a part of a plunger 23. The plunger 23 is connected with an actuator 20. The actuator 20 is the armature of a solenoid. This solenoid also has a permanent magnet, which maintains the actuator 20 in the initial position shown in FIGS. 1 and 2. In this case the actuator 20 is maintained prestressed against the magnetic force by a spring 21. The spring 21 is supported on a holder of the actuator 20.

An operating part 40 is assigned to the actuator 20 and has two levers 41, 42 and is pivotably seated in a bearing 42 on a housing element 30 of the lock housing. The first lever 41 protrudes into the area of the actuator 20 and in an initial position is located a short distance away from the holder 22. The second lever 42 protrudes in the area of a key receiver 31 of the housing element 30. The key element 33 has a stop which, in the initial position, rests against a counter-face of the housing element 30. The key element 33 is maintained in the initial position by the lever 43 that is supported on the stop 34 by a shoulder 44. In the initial position, the actuating element is held by a spring 36. The spring 36 is held, together with the operating part 40, in a receptacle 32 of the housing element 30. The spring 36 is supported on the lever 43.

With the embodiment shown in FIGS. 1 to 3, a switching element 35 is placed into the housing element 30 and can be operated by the lever 43.

For operating the lock, first the operating part 40 is rotated out of the opened position shown in FIG. 1 into the locking position shown in FIG. 2. The bolt is then extended out of the lock housing, and the receiver 14 is located opposite the blocking piece 24.

It is now possible to enter a code via a code input system, not shown in the drawings. The user confirms the input of the code by pressing the key element 33. During this, the key element 33 operates the operating part 40 that pushes with its lever 41 against the holder 22. During this the actuator 20 is lifted off the permanent magnet until the force of the spring 21 is greater than the effective force of the permanent magnet. Then the spring 21 pushes the blocking piece 24 into the receiver 14. The actuating element 10 is then blocked from being rotated. The operating part 40 is automatically returned into its initial position by the action of the spring 36. The blocked locking position is shown in FIG. 3.

By actuating the key element 33, the lever 43 is also pushed against the switching element 35. The levers 41 and 43 are arranged so that the switching element can only be operated if the blocking piece 24 assuredly takes up its blocking position associated with the locked position.

If the lock is to be opened again, the user inputs the code and confirms it, possibly with the key element 33. Then the solenoid is activated and pulls the actuator 20 out of its position shown in FIG. 3 into the initial position shown in FIG. 1. The actuator 20 then rests against the permanent magnet. The actuating element 10 can now be freely rotated again.

One embodiment of this invention, which is modified with respect to FIGS. 1 to 3, is shown in FIG. 4. In this case the end position of the blocking piece 24 is interrogated by a switching element 35 assigned to the holder 22. The switching element 35 outputs an electric switching signal as soon as the blocking piece 24 reaches the receiver 14.

The switching element 35 can also be arranged at other locations which are suitable for interrogating the position of the blocking piece 24.

German Patent Reference 102 37 985.8, the priority document corresponding to this invention, and its teachings are incorporated, by reference, into this specification.

What is claimed is:

1. A lock with a bolt that can be displaced by an actuating element (10) between an opened position and a locking position, wherein a blocking piece (24) which blocks the actuating element (10) in the locking position is assigned to the actuating element (10), and wherein the blocking piece (24) can be moved from the locking position into the opened position by a solenoid, the lock comprising:
the blocking piece (24) movable out of the opened position into the locking position by a manually operable actuating element (40), and
a switching element (35) emitting a switching signal when the blocking piece (24) one of reaches the locking position and transitions from the opened position into the locking position.

2. The lock in accordance with claim 1, wherein the actuating element (40) has a lever (41) which moves the blocking piece (24) from the opened position into the locking position by a key element (33).

3. The lock in accordance with claim 2, wherein the blocking piece (24) is a part of an actuator (20) which in the opened position is maintained under a spring prestress against a permanent magnet, and the actuator (20) is lifted off the permanent magnet by the lever (41).

4. The lock in accordance with claim 2, wherein the blocking piece (24) is a part of an actuator (20) which, in the locking position, is maintained against a permanent magnet, and the actuator (20) is movable from the opened position to the locking position by a lever (41) against a force of a spring.

5. The lock in accordance with claim 4, wherein the actuating element (40) is maintained under a spring tension in an initial position associated with the opened position of the lock.

6. The lock in accordance with claim 5, wherein the switching element (35) is operated one of indirectly and directly by the actuating element (40) for emitting the switching signal.

7. The lock in accordance with claim 6, wherein the switching element (35) is one of indirectly and directly operated by one of the blocking piece (24) and the actuator (20) which is connected with the blocking piece (24).

8. The lock in accordance with claim 7, wherein the actuator (20) is an armature of the solenoid.

9. The lock in accordance with claim 8, wherein the actuating element (10) is rotatably seated around an axis of rotation (15) in a lock housing, and the actuating element (10) has a receptacle (14) for the blocking piece (24) which forms a stop in a circumferential direction on at least one of two sides of the inserted blocking piece (24).

10. The lock in accordance with claim 9, wherein in the locking position the actuating element (10) blocks a displacement in a direction toward the actuating element (10).

11. The lock in accordance with claim 1, wherein the blocking piece (24) is a part of an actuator (20) which, in the locking position, is maintained against a permanent magnet, and the actuator (20) is movable from the opened position to the locking position by a lever (41) against a force of a spring.

12. The lock in accordance with claim 2, wherein the actuating element (40) is maintained under a spring tension in an initial position associated with the opened position of the lock.

13. The lock in accordance with claim 2, wherein the switching element (3 5) is operated one of indirectly and directly by the actuating element (40) for emitting the switching signal.

14. The lock in accordance with claim 1, wherein the switching element (35) is one of indirectly and directly operated by one of the blocking piece (24) and the actuator (20) which is connected with the blocking piece (24).

15. The lock in accordance with claim 3, wherein the actuator (20) is an armature of the solenoid.

16. The lock in accordance with claim 1, wherein the actuating element (10) is rotatably seated around an axis of rotation (15) in a lock housing, and the actuating element (10) has a receptacle (14) for the blocking piece (24) which forms a stop in a circumferential direction on at least one of two sides of the inserted blocking piece (24).

17. The lock in accordance with claim 1, wherein in the locking position the actuating element (10) blocks a displacement in a direction toward the actuating element (10).
